(19) United States
(12) Patent Application Publication
(10) Pub. No.: US 2016/0115876 A1
(43) Pub. Date: Apr. 28, 2016

(54) INTERNAL COMBUSTION ENGINE

(71) Applicant: TOYOTA JIDOSHA KABUSHIKI KAISHA, Toyota-shi, Aichi-ken (JP)

(72) Inventor: Koichi HOSHI, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/896,125

(22) PCT Filed: Jun. 5, 2014
(86) PCT No.: PCT/IB2014/000967

§ 371 Date: Dec. 4, 2015

(30) Foreign Application Priority Data
Jun. 6, 2013 (JP) 2013-120114

(51) Int. Cl. F02D 13/02

(52) U.S. Cl. CPC F02D 13/0207; F02D 13/0257; F02D 13/0265; F02D 2013/0292

(57) ABSTRACT

An internal combustion engine includes a piston, a plurality of intake valves, an exhaust valve, a valve drive unit, an intake valve halting unit, an injector, and an ECU. The ECU configured to: (a) control the valve drive unit so as to close the exhaust valve on an advance side of the exhaust top-dead-center of the piston, when an engine temperature is lower than a prescribed value; (b) control the intake valve halting unit so as to halt the operation of the portion of intake valves in a closed state, when the engine temperature is lower than the prescribed value; and (c) control the valve control unit so as to form a negative overlap between the exhaust valve and the intake valve other than the portion of intake valves, among the plurality of intake valves, when the engine temperature is lower than the prescribed value.

### BACKGROUND OF THE INVENTION

1. Field of the Invention

This invention relates to an internal combustion engine.

2. Description of Related Art

In an internal combustion engine, a negative overlap may be formed between the intake valve and the exhaust valve. Japanese Patent Application Publication No. 2008-291686 (JP 2008-291686 A) discloses a control apparatus for an internal combustion engine which performs early closing control of the exhaust valve. This control apparatus forms a negative overlap by early closing control of the exhaust valve. JP 2008-291686 A also discloses combining early closing control of the exhaust valve with intake-asynchronous injection. Japanese Patent Application Publication No. 2004-263659 (JP 2004-263659 A), Japanese Patent Application Publication No. 2012-167593 (JP 2012-167593 A), Japanese Patent Application Publication No. 2003-293802 (JP 2003-293802 A), Japanese Patent Application Publication No. 2005-248766 (JP 2005-248766 A), Japanese Patent Application Publication No. 2002-332902 (JP 2002-332902 A) and Japanese Patent Application Publication No. 2001-12261 (JP 2001-12261 A) disclose technologies for halting the operation of a portion of valves among a plurality of intake valves and a plurality of exhaust valves.

When a negative overlap is formed in the internal combustion engine, then it is possible to achieve recompression of the residual gas inside the cylinder. In this case, it is possible to generate blow-back of hot high-pressure gas from the cylinder and into the intake passage when the intake valve is opened. As a result of this, it is possible to further atomize the fuel injected into the intake passage, by means of the blow-back gas.

### SUMMARY OF THE INVENTION

The extent of atomization of the fuel varies depending on the mode of blow-back of the gas. More specifically, for example, the stronger the blow-back of gas, the more readily the fuel can be atomized. Consequently, in this respect, there is still scope for further improvement in achieving atomization of fuel injected into the intake passage, by blow-back of gas.

This invention provides an internal combustion engine which is capable of atomizing fuel injected into an intake passage by blow-back of gas.

An internal combustion engine relating to one aspect of this invention includes a piston, a plurality of intake valves, an exhaust valve; a valve drive unit, an intake valve halting unit, an injector and an electronic control unit (ECU). The piston is configured to be adjacent to a combustion chamber of the internal combustion engine. The plurality of intake valves is configured to independently open and close a plurality of intake passages communicating with the combustion chamber. The exhaust valve is configured to open and close an exhaust passage communicating with the combustion chamber. The valve drive unit is configured to change at least a valve closing time of the exhaust valve, of valve characteristics of the plurality of intake valves and the exhaust valve. The intake valve halting unit is configured to halt operation of a portion of intake valves, among the plurality of intake valves, in a closed state. An injector is configured to inject fuel into at least an intake passage, other than the intake passages opened and closed by the portion of intake valves, among the plurality of intake passages. The ECU is configured to: (a) control the valve drive unit so as to close the exhaust valve on an advance side of the exhaust top-dead-center of the piston, when an engine temperature is lower than a prescribed value; (b) control the intake valve halting unit so as to halt the operation of the portion of intake valves in a closed state, when the engine temperature is lower than the prescribed value; and (c) control the valve control unit so as to form a negative overlap between the exhaust valve and the intake valve other than the portion of intake valves, among the plurality of intake valves, when the engine temperature is lower than the prescribed value.

The internal combustion engine relating to the aspect of this invention may also include an exhaust valve halting unit configured to halt operation of a portion of exhaust valves, among a plurality of exhaust valves individually opening and closing a plurality of the exhaust passages, in a closed state. The ECU may be configured to: (a) control the exhaust valve halting unit so as to halt operation of the portion of exhaust valves in a closed state, when the engine temperature is lower than the prescribed value and when a bed temperature of a catalyst that cleans exhaust gas emitted from the combustion chamber is lower than a prescribed value; and (b) control the valve drive unit so as to form a negative overlap between the intake valve other than the portion of intake valves, among the plurality of intake valves, and an exhaust valve other than the portion of exhaust valves, among the plurality of exhaust valves, when the engine temperature is lower than the prescribed value and when the bed temperature of the catalyst that cleans the exhaust gas emitted from the combustion chamber is lower than the prescribed value.

According to this invention, it is possible to satisfactorily atomize the fuel injected into the intake passage by blow-back of the gas.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic drawing of an internal combustion engine;

FIG. 2 is a diagram showing intake ports;

FIG. 3 is a diagram showing an exhaust port of an internal combustion engine;

FIG. 4 is an illustrative diagram of a negative overlap;

FIG. 5 is a flowchart showing one example of a control operation by the ECU;

FIG. 6 is a first illustrative diagram relating to modification of unburned fuel; and

FIG: 7 is a second illustrative diagram relating to modification of unburned fuel.

### DETAILED DESCRIPTION OF EMBODIMENTS

Embodiments of this invention are described below with reference to the drawings.

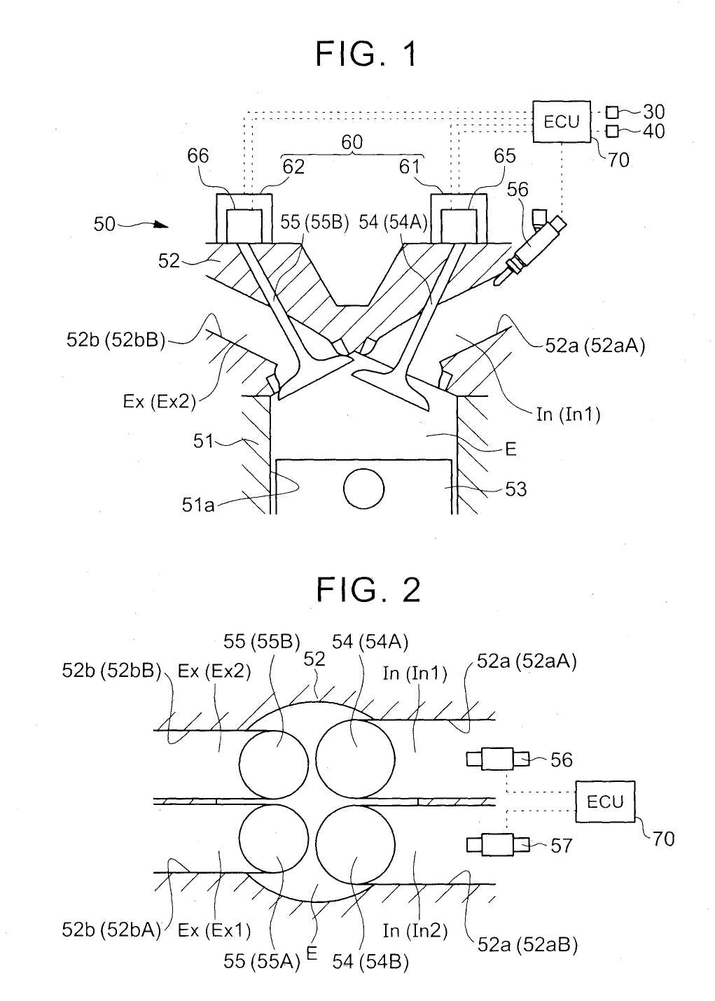

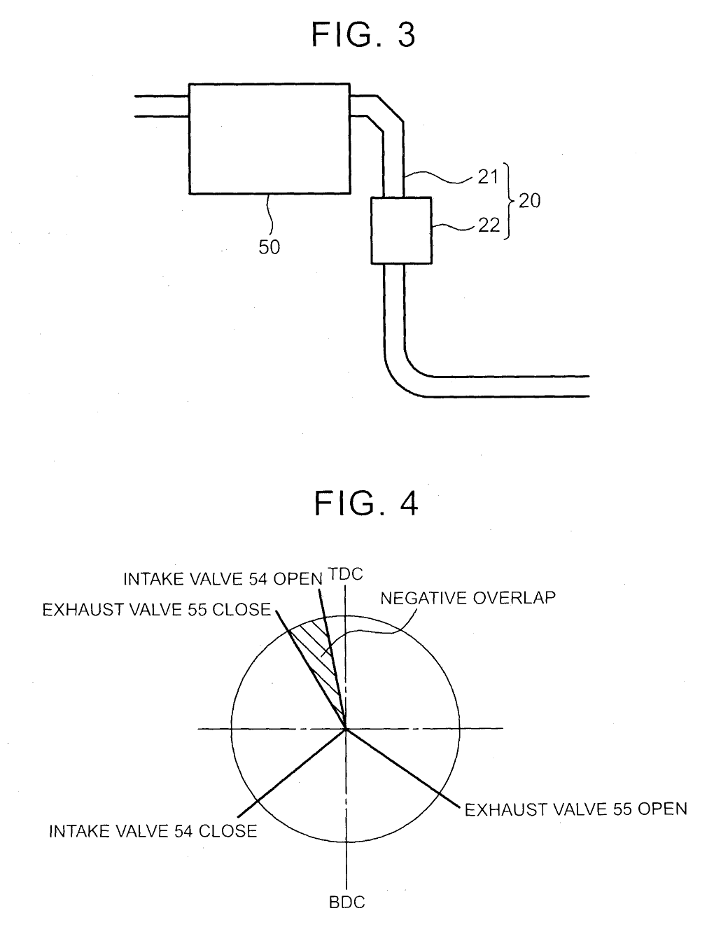

FIG. 1 is a schematic drawing of an internal combustion engine 50. FIG. 2 shows intake ports 52a, 52b. FIG. 3 shows an exhaust system 20 of the internal combustion engine 50. The internal combustion engine 50 is provided with a cylinder block 51, a cylinder head 52, a piston 53, an intake valve 54, an exhaust valve 55, fuel injection valves 56, 57, a valve drive unit 60, an intake valve halting unit 65, an exhaust valve halting unit 66 and an ECU 70. A cylinder 51a is formed in the cylinder block 51. A piston 53 is accommodated inside the cylinder 51a. The piston 53 is adjacent to a combustion chamber E. The combustion chamber E is a space enclosed by the cylinder block 51, the cylinder head 52 and the piston 53.

The cylinder head 52 is fixed to the upper surface of the cylinder block 51. An intake port 52a for guiding intake air into the combustion chamber E and an exhaust port 52b for expelling gas from the combustion chamber E are formed in the cylinder head 52. The intake port 52a and the exhaust port 52b are both provided as a plurality of ports (here, two ports each). The plurality of intake ports 52a form a plurality of intake passages In which communicate with the combustion chamber E, and the plurality of exhaust ports 52b form a plurality of exhaust passages Ex which communicate with the combustion chamber E. The intake valves 54 and the exhaust valves 55 are provided for the combustion chamber E. The internal combustion engine 50 is provided with a plurality of intake valves 54 and exhaust valves 55 (in this case, two valves each). The plurality of intake valves 54 respectively open and close the plurality of intake passages In, and the plurality of exhaust valves 55 respectively open and close the plurality of exhaust passages Ex.

The internal combustion engine 50 is provided with intake ports 52aA and 52aB as the plurality of intake ports 52a. The intake port 52aA is a first intake port which forms an intake passage In1. The intake port 52aB is a second intake port which forms an intake passage In2. Therefore, the internal combustion engine 50 has the intake passage In1 which is a first intake passage and the intake passage In2 which is a second intake passage, as the plurality of intake passages In. If, for example, the intake port 52a is a siamese type port which branches midway into a plurality of ports that communicate with the combustion chamber E, then the plurality of intake passages In means the individual intake passages where the plurality of branches are formed in the intake port 52a.

The internal combustion engine 50 is provided with exhaust ports 52bA and 52bB as the plurality of exhaust ports 52b. The exhaust port 52bA is a first intake port which forms an exhaust passage Ex1. The exhaust port 52bB is a second exhaust port which forms an exhaust passage Ex2. Therefore, the internal combustion engine 50 has, the exhaust passage Ex1 which is a first exhaust passage and the exhaust passage Ex2 which is a second exhaust passage, as the plurality of exhaust passages Ex.

The internal combustion engine 50 is provided with the intake valves 54A and 54B as the plurality of intake valves 54. Furthermore, the internal combustion engine 50 is also provided with the exhaust valves 55A and 55B as the plurality of exhaust valves 55. The intake valve 54A is a first intake valve which opens and closes the intake passage In1. The intake valve 54B is a second intake valve which opens and closes the intake passage In2. The exhaust valve 55A is a first exhaust valve which opens and closes the exhaust passage Ex1. The exhaust valve 55B is a second exhaust valve which opens and closes the exhaust passage Ex2.

The plurality of intake ports 52a and the plurality of exhaust ports 52b are provided in such a manner that the intake port 52aA and the exhaust port 52bB are mutually opposing along the intake/exhaust direction. Therefore, the intake valve 54A and the exhaust valve 55A are provided so as to be disposed respectively in opposing fashion to the exhaust valve 55B and the intake valve 54B, along the intake/exhaust direction. The intake valve 54A corresponds to a portion of intake valves from among the plurality of intake valves 54. The exhaust valve 55A corresponds to a portion of exhaust valves from among the plurality of exhaust valves 55. The arrangement of the intake valves 54A and 54B and the arrangement of the exhaust valves 55A, 55B may be the reverse of that described above.

The fuel injection valves 56, 57 are a plurality of injectors which are provided in the cylinder head 52. The fuel injection valves 56, 57 inject fuel individually into the plurality of intake passages In. The fuel injection valve 56, which is a first injector, injects fuel into the intake passage In1, and the fuel injection valve 57, which is a second injector, injects fuel into the intake passage In2. The fuel injection valve 57 is an injector which injects fuel into at least one of the plurality of intake passages In (in this case, the intake passage In2), and corresponds to the injector which injects fuel into at least the intake passage other than the intake passage In1 that is opened and closed by the intake valve 54A, of the plurality of intake passages In, (more specifically, into the intake passage In2).

The internal combustion engine 50 is provided with fuel injection valves 56, 57 which are a plurality of injectors including the fuel injection valve 57, and the fuel injection valve 57, which is a portion of the fuel injection valves 56, 57, injects fuel into the intake passage In2, which is at least the intake passage other than the intake passage In1 that is opened and closed by the intake valve 54A, of the plurality of intake passages In.

A valve drive unit 60 is provided in the cylinder head 52. The valve drive unit 60 is provided with an intake-side variable valve drive unit 61 which can vary the valve characteristics of the plurality of intake valves 54, and an exhaust-side variable valve drive unit 62 which can vary the valve characteristics of the exhaust valve 55 (in this case, the plurality of exhaust valve 55). The valve characteristics are the valve opening time, the valve closing time, the lift amount, or a combination of these (for example, opening and closing times, or closing time and lift amount, or opening time, closing time and lift amount, etc.).

More specifically, the intake-side variable valve drive unit 61 is an intake-side valve timing variation mechanism which changes the opening and closing times of the plurality of intake valves 54. The exhaust-side variable valve drive unit 62 is an exhaust-side valve timing variation mechanism which changes the opening and closing times of the exhaust valve 55 (in this case, the plurality of exhaust valves 55). To give specific details, the variable valve drive mechanisms 61, 62 are each hydraulically driven, and include an oil control unit which controls the transmission of hydraulic pressure.

By providing the valve drive unit 60 with the exhaust-side variable valve drive unit 62, a valve drive unit is obtained which changes at least the valve closing time of the exhaust valves 55, of the valve characteristics of the plurality of intake valves 54 and the exhaust valve 55 (in this case, the plurality of exhaust valves 55). This valve drive unit can be composed by at least the exhaust-side variable valve drive unit 62, of the intake-side variable valve drive unit 61 and the exhaust-side variable valve drive unit 62. The valve drive unit is not necessarily limited to that described above, and may also be another valve drive unit capable of changing the closing time of the exhaust valves 55.

The intake valve halting unit 65 is provided for the intake valves 54. The exhaust valve halting unit 66 is provided for the exhaust valves 55. The intake valve halting unit 65 halts the operation of the intake valve 54A, from among the plurality of intake valves 54, in the closed state. The exhaust valve halting unit 66 halts the operation of the exhaust valve 55A, from among the plurality of exhaust valves 55, in the closed state. To give specific details, the intake valve halting unit 65 and the exhaust valve halting unit 66 may employ the variable valve drive unit for an internal combustion engine disclosed in JP 2012-167593 A described above, for example.

The exhaust system 20 is connected to the internal combustion engine 50. The exhaust system 20 is provided with an exhaust pipe 21 and a catalyst 22. The exhaust pipe 21 forms an exhaust passage. The exhaust passage communicates with the combustion chamber E via a plurality of exhaust passages Ex. The catalyst 22 is provided so as to be interposed in the exhaust pipe 21. The catalyst 22 cleans the exhaust gas emitted from the combustion chamber E.

The ECU 70 is an electronic control device, which is electrically connected to the following control objects: the fuel injection valves 56, 57, the valve drive unit 60 (more specifically, the oil control units of the variable valve drive mechanisms 61, 62), the intake valve halting unit 65, and the exhaust valve halting unit 66. Furthermore, a first sensor group 30 for detecting the state of operation of the engine, and a second sensor group 40 for detecting the state of the valve drive unit 60 are connected electrically as sensors/Switches, to the ECU 70.

The first sensor group 30 includes, for example: a crank angle sensor for detecting the crank angle, an air flow meter for measuring the intake air amount in the internal combustion engine 50, an accelerator depression amount sensor for making an acceleration request to the internal combustion engine 50, an idle SW for detecting an idling operation, a water temperature sensor for detecting the cooling water temperature ethw of the internal combustion engine 50, an ignition switch, an A/F sensor for detecting the air-fuel ratio linearly on the basis of the oxygen concentration in the exhaust gas to the upstream side of the catalyst 22, and an O₂ sensor for detecting whether the air-fuel ratio is rich or lean compared to the stoichiometric air-fuel ratio, on the basis of the oxygen concentration in the exhaust gas to the downstream side of the catalyst 22. The second sensor group 40 includes, for example, a hydraulic sensor which detects the oil pressure transmitted to the variable valve drive mechanisms 61, 62, and a sensor for detecting the opening time and the closing time of the intake and exhaust valves 54, 55.

In the ECU 70, a central processing unit (CPU) executes processing while using the temporary storage area of a random access memory (RAM), as and when necessary, on the basis of a program stored in a read only memory (ROM), whereby the first to third control units, the injection control unit and the fuel/air ratio control unit described below are achieved, for example. These compositions may be achieved by a plurality of electronic control devices, for example.

The first control unit controls a valve drive unit 60. The first control unit controls the valve drive unit 60 in such a manner that, for example, the exhaust valve 55 (in this case, a plurality of exhaust valves 55) closes to the advance side of the exhaust top-dead-center of the piston 53. Specifically, the valve drive unit 60 which is controlled as described above by the first control unit functions as described above when the engine temperature T1 is lower than the prescribed value α. Cases where the engine temperature T1 is lower than the prescribed value α include an idling operation when the engine is started up from cold. To achieve this function in the valve drive unit 60, the valve drive unit 60 can be controlled as described above, in advance, when the engine is stopped, for example. The valve drive unit 60 may be understood as a composition which also includes the first control unit.

The second control unit controls the intake valve halting unit 65. When the engine temperature T1 is lower than the prescribed value α, then the second control unit controls the intake valve halting unit 65 so as to halt the operation of the intake valve 54A in a closed state. Consequently, when the engine temperature T1 is lower than the prescribed value α, then the intake valve halting unit 65 halts the operation of the intake valve 54A in a closed state. The intake valve halting unit 65 may be understood as a composition which also includes the second control unit.

When the engine temperature T1 is lower than the prescribed value α, then the valve drive unit 60 which closes the exhaust valve 55 on the advance side of the exhaust top-dead-center of the piston 53, and the intake valve halting unit 65 which halts the operation of the intake valve 54A in a closed state, form a negative overlap between the intake valve other than the intake valve 54A, of the plurality of intake valves 54, (in other words, the intake valve 54B) and the exhaust valve 55, when the engine temperature T1 is lower than the prescribed value α.

FIG. 4 is an illustrative diagram of a negative overlap. As shown in FIG. 4, the negative overlap is an overlap in the closing times between the intake valve 54 and the exhaust valve 55 which is formed in the period from the closing time of the exhaust valve 55 to the opening time of the intake valve 54. When the engine temperature T1 is lower than the prescribed value α, then the valve drive unit 60 can set the opening time of the intake valves 54 to the advance side of the exhaust top-dead-center of the piston 53.

When the engine temperature T1 is lower than the prescribed value α, and when the bed temperature T2 of the catalyst 22 is lower than the prescribed value β (for example, the active temperature), then the third control unit controls the exhaust valve halting unit 66 so as to halt the operation of the exhaust valve 55A in the closed state. Consequently, the exhaust valve halting unit 66 halts the operation of the exhaust valve 55A in a closed state, in such cases. The exhaust valve halting unit 66 may be understood as a composition which also includes the third control unit.

When the engine temperature T1 is lower than the prescribed value α and when the bed temperature T2 is lower than the prescribed value β, then the exhaust valve halting unit 66 which halts the operation of the exhaust valve 55A in a closed state, together with the valve drive unit 60 and the intake valve halting unit 65, forms a negative overlap between the intake valve other than the intake valve 54A, of the plurality of intake valves 54 (more specifically, the intake valve 54B), and the exhaust valve other than the exhaust valve 55A, of the plurality of exhaust valves 55 (more specifically, the exhaust valve 55B).

When the engine temperature T1 is higher than the prescribed value α (in this case, equal to or greater than the prescribed value α), and when the operating state of the engine is not an idling operation, or when a cancellation condition for the negative overlap has been established, then the second control unit controls the intake valve halting unit 65 so as to cancel the operation halt of the intake valve 54A. When the engine temperature T2 is higher than the prescribed value β (in this case, equal to or greater than the prescribed value β, and when the operating state of the engine is not an idling operation, or when a cancellation condition for the negative overlap has been established, then the third control unit controls the exhaust valve halting unit 66 so as to cancel the operation halt of the exhaust valve 55A. The reasons for cancelling the negative overlap are as follows.

More specifically, achieving atomization of the fuel by blow-back of the gas by forming the negative overlap, when the engine is started up from cold, is effective in reducing exhaust emissions. However, the gas remaining inside the cylinder due to the formation of a negative overlap also has an action of slowing the combustion. Therefore, continuing the negative overlap also leads to delay in the warming of the catalyst 22, due to producing a decline in the exhaust temperature.

Consequently, in order to obtain a good effect in reducing the exhaust emissions, it is effective to cancel the negative overlap when a prescribed time has elapsed after starting the internal combustion engine 50. Therefore, when the engine is started up from cold, for example, the expiration of a prescribed time period can be set as a cancellation condition for the negative overlap. When a cancellation condition for the negative overlap is established, then the first control unit is able to cancel the negative overlap by controlling the valve drive unit 60 so as to delay the valve closing time of the exhaust valve 55.

The injection control unit carries out fuel injection control of the fuel injection valves 56, 57. The injection control unit controls the fuel injection valve 56 so as to halt the fuel injection when the engine temperature T1 is lower than the prescribed value α, and also control the fuel injection valve 57 so as to carry out intake-asynchronous injection. Therefore, when the engine temperature T1 is lower than the prescribed value α, then the fuel injection valve 56 halts fuel injection and the fuel injection valve 57 carries out intake-asynchronous injection. Intake-asynchronous injection means fuel injection that is carried out before the plurality of intake valves 54 open and can be carried out in the exhaust stroke.

When the engine temperature T1 is higher than the prescribed value α, and when the operating state of the engine is not an idling operation, or when a cancellation condition for the negative overlap is established, then the injection control unit controls the fuel injection valve 56 so as to cancel the halting of fuel injection, and also controls the fuel injection valve 57 so as to cancel the intake-asynchronous injection. The injector may be understood as a composition which also includes the injection control unit.

In the air-fuel ratio control unit, the intake valve halting unit 65 halts the operation of the intake valve 54A in a closed state, and the fuel injection valve 56 halts fuel injection, and furthermore when the fuel injection valve 57 is performing intake-asynchronous injection, then the air-fuel ratio control unit implements enrichment control to make the exhaust air-fuel ratio richer than the stoichiometric air-fuel ratio. The air-fuel ratio control unit implements enrichment control when the engine temperature T1 is lower than a prescribed value α.

The enrichment control can be carried out, for example, by increasing, by a prescribed amount, the fuel injection amount of the fuel injection valve 57 during an idling operation, which is set in advance in such a manner that the exhaust air-fuel ratio becomes a stoichiometric air-fuel ratio. In enrichment control, the exhaust air-fuel ratio is controlled so as to become slightly richer than the stoichiometric air-fuel ratio. The air-fuel ratio control unit cancels enrichment control when the engine temperature T1 is higher than a prescribed value α, when the engine operating state is not an idling operation, or when a cancellation condition for the negative overlap is established.

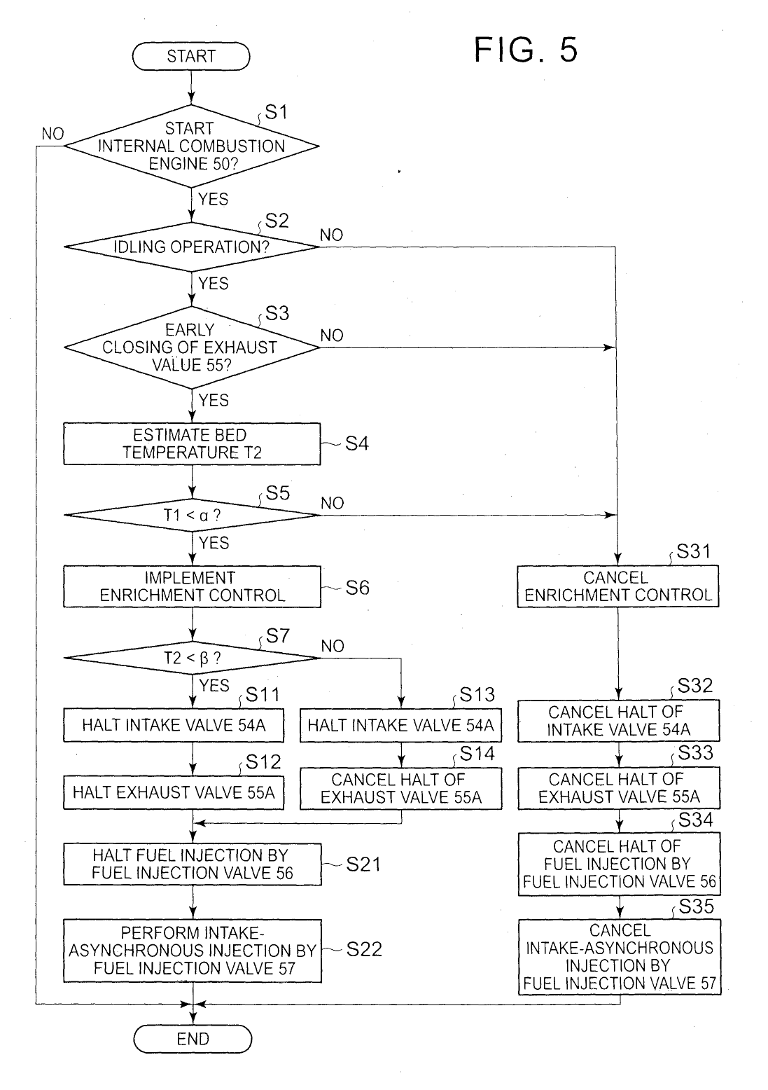

Next, one example of a control operation by the ECU 70 will be described with reference to the flowchart shown in FIG. 5. The ECU 70 determines whether or not the internal combustion engine 50 has been started (step S1). The ECU 70 can determine whether or not the internal combustion engine 50 has been started on the basis of the output of the ignition switch, for example. When a negative result is determined, then the flowchart is temporarily terminated. When an affirmative result is determined, then the ECU 70 determines whether or not the engine operating state is an idling operation (step S2). The ECU 70 can determine whether or not the engine operating state is an idling operation on the basis of the output of the idle switch, for example. When an affirmative result is determined, the ECU 70 determines whether or not the exhaust valve 55 has closed early (step S3). In step S3, more specifically, the ECU 70 determines whether or not a negative overlap has been formed. In step S3, when a cancellation condition for the negative overlap has been established, then a negative result is determined.

When an affirmative result is determined in step S3, then the ECU 70 estimates the bed temperature T2 (step S4). The bed temperature T2 can be estimated on the basis of the cumulative value of the intake air amount, from the start of the engine, for example. The cumulative value of the intake air amount can be calculated on the basis of the output of an air flow meter, for example. Thereupon, the ECU 70 determines whether or not the engine temperature T1 is lower than the prescribed value α (step S5). The ECU 70 can determine whether or not the engine temperature T1 is lower than the prescribed value α, for example, on the basis of whether or not the cooling water temperature ethw is lower than a prescribed value. The ECU 70 may also determine whether or not the engine temperature T1 is lower than the prescribed value α, on the basis of whether or not the bed temperature T2, for example, is a lower than a prescribed value β′, which is a prescribed value higher than the prescribed value β.

When an affirmative result is determined in step S5, then the ECU 70 implements enrichment control (step S6). Furthermore, the ECU 70 also determines whether or not the bed temperature T2 is lower than the prescribed value β (step S7). When an affirmative result is determined in step S7, then the ECU 70 halts the operation of the intake valve 54A in the closed state (step S11), and halts the operation of the exhaust valve 55A in the closed state (step S12). Furthermore, the ECU 70 also controls the fuel injection valve 56 so as to halt fuel injection (step S21), and controls the fuel injection valve 57 so as to carry out intake-asynchronous injection (step S22). After step S22, the flowchart is terminated temporarily.

When a negative result is determined in step S7, then the ECU 70 halts the operation of the intake valve 54A in the closed state (step S13), and cancels the halting of operation of the exhaust valve 55A (step S14). After step S14, the procedure advances to step S21.

Following a negative result in step S2, S3 or S5, the ECU 70 cancels the enrichment control (step S31). Furthermore, the ECU 70 also cancels the halting of operation of the intake valve 54A (step S32), and cancels the halting of operation of the exhaust valve 55A (step S33). Moreover, the ECU 70 controls the fuel injection valve 56 so as to cancel the halting of fuel injection (step S34), and controls the fuel injection valve 57 so as to cancel intake-asynchronous injection (step S35). After step S35, the flowchart is terminated.

Next, the main actions and effects of the internal combustion engine 50 will be described. In the internal combustion engine 50, when the engine temperature T1 is lower than the prescribed value α, then the valve drive unit 60 closes the exhaust valve 55 on the advance side of the exhaust top-dead-center of the piston 53, and furthermore the intake valve halting unit 65 halts the operation of the intake valve 54A in a closed state and the valve drive unit 60 and the intake valve halting unit 65 form a negative overlap between the intake valve 54B and the exhaust valve 55.

Therefore, by opening the intake valve 54B of the plurality of intake valves 54 after forming a negative overlap, the internal combustion engine 50 is able to reduce the total cross-sectional area of the plurality of intake passages In communicating with the combustion chamber E. As a result of this, it is possible satisfactorily to atomize the fuel injected into the intake passage In2 by the fuel injection valve 57, by blow-back of gas having a raised flow speed. More specifically, the internal combustion engine 50 is able to reduce fuel consumption and reduce exhaust emissions, by achieving atomization of the fuel.

In addition to the atomization of the fuel, by taking the blown-back hot, high-pressure gas into the cylinder in the intake stroke, the internal combustion engine 50 can achieve a reduction in the amount of fuel which adheres to the interior of the cylinder, and an increase in the vaporized fuel. By increasing the vaporized fuel which contributes to combustion, it is also possible to raise the homogeneity of the air mixture. Therefore, by raising the homogeneity of the air mixture, the internal combustion engine 50 can also make the combustion more resistant to the increase in residual gas in the cylinder.

More specifically, the internal combustion engine 50 is also provided with an exhaust valve halting unit 66, and when the engine temperature T1 is lower than the prescribed value α, and the bed temperature T2 is lower than the prescribed value β, then the exhaust valve halting unit 66 also halts the operation of the exhaust valve 55A in a closed state, and the exhaust valve halting unit 66, together with the valve drive unit 60 and the intake valve halting unit 65, forms a negative overlap between the intake valve 54B and the exhaust valve 55B.

An internal combustion engine 50 having this composition can reduce the gas scavenging efficiency from the cylinder, by halting the exhaust valve 55A in a closed state. Therefore, the internal combustion engine 50 having This composition can increase the amount of gas remaining in the cylinder when a negative overlap is formed. As a result of this, it is possible to achieve more satisfactory atomization of the fuel by further increasing the blow-back flow rate of the gas. The internal combustion engine 50 having this composition can also reduce exhaust emissions as described below, by increasing the amount of residual gas in the cylinder.

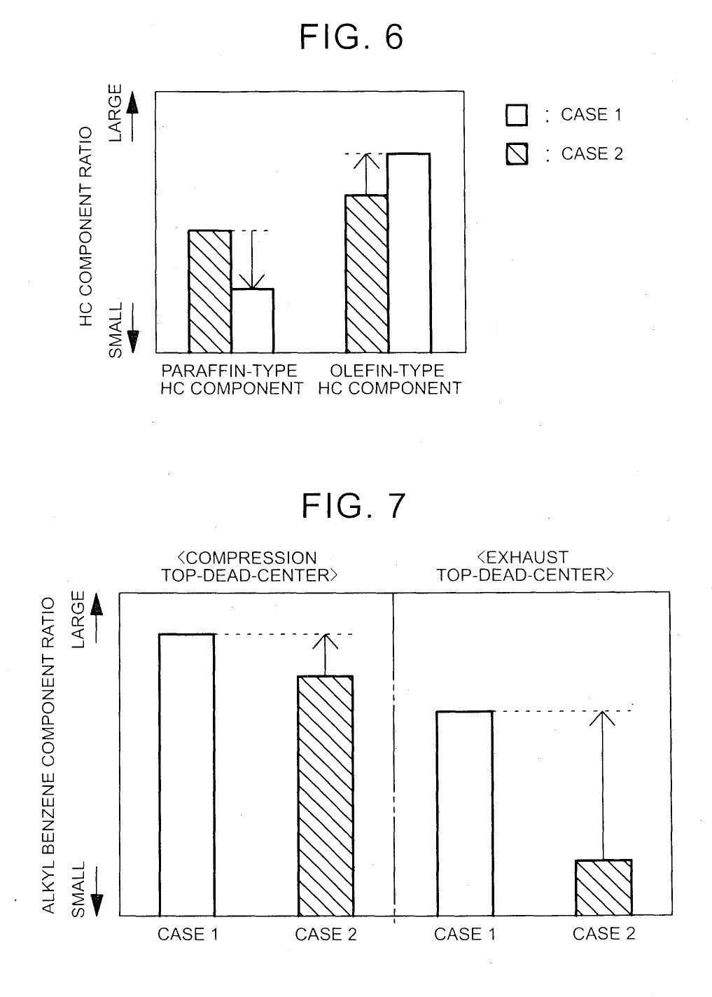

FIG. 6 is a first illustrative diagram relating to modification of the unburned fuel contained in the gas in the cylinder. FIG. 7 is a second illustrative diagram relating to modification of the unburned fuel contained in the gas in the cylinder. FIG. 6 shows the ratio between paraffin-type hydrocarbon (HC) components and olefin-type HC components in the gas in the cylinder, at the exhaust top-dead-center. FIG. 7 shows the ratio of alkyl benzene-type HC components in the aromatic HC components. FIG. 7 shows cases where the gas in the cylinder containing aromatic HC components is the gas in the cylinder at the compression top-dead-center, and the gas in the cylinder at the exhaust top-dead-center. Case 1 shown in FIG. 6 and FIG. 7 is a case where a negative overlap is formed, and Case 2 is a case where no negative overlap is formed.

As shown in FIG. 6, it can be seen that in Case 1, the ratio of the paraffin-type HC components which have low reactivity in the catalyst 22 is decreased, and the ratio of the olefin-type HC components which have high reactivity in the catalyst 22 is increased, in comparison with Case 2. As shown in FIG. 7, it can be seen that in Case 1, the ratio of the alkyl benzene-type HC components which have high reactivity in the catalyst 22 is increased, in comparison with Case 2. Furthermore, it can also be seen that this tendency is the same both when the gas in the cylinder is at the compression top-dead-center and contains new air, fuel and residual gas, and when the gas in the cylinder is as the exhaust top-dead-center and contains residual gas.

More specifically, the modification of the unburned fuel occurs in a baking state of the unburned fuel which is enclosed in the cylinder while still at a hot temperature, due to the formation of the negative overlap. Consequently, by increasing the amount of residual gas inside the cylinder, the internal combustion engine 50 can reduce exhaust emissions by promoting modification of the unburned fuel to HC components which have excellent catalytic reactivity. The internal combustion engine 50 is also able to reduce the NOx contained in the exhaust gas, by increasing the amount of residual gas inside the cylinder.

Specifically, the internal combustion engine 50 is provided with fuel injection valves 56, 57 which are a plurality of injectors including the fuel injection valve 57, and is composed so that the fuel injection valve 57, which is a portion of the fuel injection valves 56, 57, injects fuel into the intake passage In2, which is at least the intake passage other than the intake passage In1 which is opened and closed by the intake valve 54A, of the plurality of intake passages In. More specifically, the internal combustion engine 50 is able to atomize the fuel when this composition is adopted, for example.

Specifically, the internal combustion engine 50 is composed in such a manner that, when the engine temperature T1 is lower than the prescribed value α, then the fuel injection valve 56 which is the injector other than the fuel injection valve 57, of the fuel injection valves 56, 57, halts fuel injection, and the fuel injection valve 57 performs intake-asynchronous injection. The internal combustion engine 50 having this composition can atomize the fuel injection in the intake-asynchronous injection from the fuel injection valve 57, while preventing injection of unwanted fuel from the fuel injection valve 56. In this case, specifically, the internal combustion engine 50 can achieve atomization of the fuel by blowing out the fuel injected in the intake-asynchronous injection which has collected on the head back of the intake valve 54B.

Specifically, the internal combustion engine 50 is composed so as to perform enrichment control for making the exhaust air-fuel ratio richer than the stoichiometric air-fuel ratio, when the engine temperature T1 is lower than the prescribed value α. The internal combustion engine 50 having this composition can further improve the catalytic reactivity of the exhaust gas at the timing that the catalyst 22 is activated.

Specifically, in the internal combustion engine 50, when the engine temperature T2 is higher than the prescribed value β, and when the operating state of the engine is not an idling operation, or when a cancellation condition for the negative overlap has been established, then the exhaust valve halting unit 66 cancels the halting of operation of the exhaust valve 55A. The internal combustion engine 50 having this composition can reduce the amount of gas remaining inside the cylinder, by operating the exhaust valve 55A. Consequently, the internal combustion engine 50 having this composition can achieve both warm-up of the catalyst 22 and stabilization of the combustion.

Specifically, in the internal combustion engine 50, when the engine temperature T1 is higher than the prescribed value α, and when the operating state of the engine is not an idling operation, or when a cancellation condition for the negative overlap has been established, then the intake valve halting unit 65 cancels the halting of operation of the intake valve 54A. Furthermore, the fuel injection valve 56 also cancels the halting of fuel injection, in addition to which the fuel injection valve 57 cancels intake-asynchronous injection, and the enrichment control is cancelled. The internal combustion engine 50 having this composition can achieve atomization of the fuel while enabling suitable driving in accordance with the circumstances.

An embodiment has been described in detail above, but this invention is not limited to this specific embodiment and can be changed and modified within the scope of the essence of this invention described in the claims.

For example, if the intake port is a siamese type port, then the injector may be an injector which injects fuel respectively into the plurality of intake passages formed by the respective branches provided in the intake port.

What is claimed is:

1. An internal combustion engine, comprising:
a piston configured to be adjacent to a combustion chamber of the internal combustion engine;
a plurality of intake valves configured to independently open and close a plurality of intake passages communicating with the combustion chamber;
an exhaust valve configured to open and close an exhaust passage communicating with the combustion chamber;
a valve drive unit configured to change at least a valve closing time of the exhaust valve, of valve characteristics of the plurality of intake valves and the exhaust valve;
an intake valve halting unit configured to halt operation of a portion of intake valves, among the plurality of intake valves, in a closed state;
an injector configured to inject fuel into at least an intake passage, other than the intake passages opened and closed by the portion of intake valves, among the plurality of intake passages; and
an ECU configured to:
(a) control the valve drive unit so as to close the exhaust valve on an advance side of an exhaust top-dead-center of the piston, when an engine temperature is lower than a prescribed value;
(b) control the intake valve halting unit so as to halt the operation of the portion of intake valves in a closed state, when the engine temperature is lower than the prescribed value; and
(c) control the valve drive unit so as to form a negative overlap between the exhaust valve and the intake valve, other than the portion of intake valves, among the plurality of intake valves, when the engine temperature is lower than the prescribed value.

2. The internal combustion engine according to claim 1, further comprising:
an exhaust valve halting unit configured to halt operation of a portion of exhaust valves, among a plurality of exhaust valves individually opening and closing a plurality of the exhaust passages, in a closed state, wherein the ECU is configured to:
(d) control the exhaust valve halting unit so as to halt operation of the portion of exhaust valves in a closed state, when the engine temperature is lower than the prescribed value and when a bed temperature of a catalyst that cleans exhaust gas emitted from the combustion chamber is lower than a prescribed value; and
(e) control the valve drive unit so as to form a negative overlap between the intake valve other than the portion of intake valves, among the plurality of intake valves, and the exhaust valve other than the portion of exhaust valves, among the plurality of exhaust valves, when the engine temperature is lower than the prescribed value and when the bed temperature of the catalyst that cleans the exhaust gas emitted from the combustion chamber is lower than the prescribed value.
